(19) United States
(12) Patent Application Publication
(10) Pub. No.: US 2026/0279043 A1
(43) Pub. Date: Sep. 17, 2026

(54) Roof Component Identification System

(71) Applicant: TotalScope Estimating Services LLC, Boerne, TX (US)

(72) Inventors: Breson DeLater, Bulverde, TX (US); Blake Suttle, Westminster, CO (US); Drew Suttle, Boerne, TX (US); Michael Johnson, Hampstead, NC (US)

(21) Appl. No.: 19/680,151

(22) Filed: May 18, 2026

Related U.S. Application Data
(63) Continuation-in-part of application No. 19/369,055, filed on Oct. 24, 2025.
(60) Provisional application No. 63/711,654, filed on Oct. 24, 2024.

(51) Int. Cl. G06V 20/10; G06V 10/764; G06V 10/774; G06V 10/776; G06V 10/82; G06V 20/17

(52) U.S. Cl. CPC G06V 20/176; G06V 10/764; G06V 10/774; G06V 10/776; G06V 10/82; G06V 20/17

(57) ABSTRACT

A roof component identification system and method are disclosed. The system acquires roof imagery from multiple sources, including drone and ground-based cameras, and processes the imagery using machine learning models to identify and classify roofing components such as vents, chimneys, and skylights. Data cleaning, normalization, and augmentation are applied to prepare imagery for model training. The system continuously improves its accuracy by incorporating user feedback and retraining with newly collected data. A monitoring interface provides live analytics and performance metrics. The invention enables automated, scalable, and consistent roof component analysis for inspection, maintenance, and insurance applications.

### CROSS-REFERENCE TO RELATED APPLICATION

This application is a continuation-in-part of U.S. patent application Ser. No. 19/369,055 filed on Oct. 24, 2025, titled Roof Component Identification System, which claims the benefit of U.S. Provisional Application No. 63/711,654 filed on Oct. 24, 2024, titled Roof Component Identification System, the entire disclosures of which is hereby incorporated by reference.

### FIELD OF THE INVENTION

The present invention relates generally to systems and methods for computer vision and image-based structural analysis. More particularly, the invention relates to an automated system for identifying, classifying, and analyzing roofing components and features from visual data acquired through ground-based, aerial, and third-party imaging sources.

### BACKGROUND OF THE INVENTION

Roof inspections, maintenance evaluations, and insurance assessments frequently require manual review of photographic or on-site visual data to determine the condition and configuration of roofing structures. Conventional methods rely heavily on human expertise and manual identification of components such as vents, chimneys, shingles, gutters, and flashing. These manual processes are labor-intensive, prone to inconsistency, and limited in scalability.

While automated image recognition models have been developed for general object classification, they are not well-suited for the specific visual variability encountered in roofing structures. Roof imagery varies substantially in angle, lighting, weather conditions, and occlusion. Additionally, conventional systems lack a continuous improvement cycle for model reinforcement, do not integrate human feedback from field operators, and fail to maintain consistent accuracy across diverse architectural designs and imaging environments.

Therefore, there exists a need for an integrated, automated system that can efficiently collect, process, and analyze roof imagery from multiple sources, identify roof components using trained machine learning models, verify data integrity, and continuously reinforce model accuracy based on operational feedback.

### SUMMARY OF THE INVENTION

The present invention provides a Roof Component Identification System designed to process image data from multiple acquisition sources, classify roofing elements using trained deep learning models, and maintain ongoing model reinforcement through continuous retraining and data validation.

In one embodiment, the system includes a data collection subsystem configured to acquire image and video data of building roofs through both first-party collection (e.g., via human-operated cameras and drone-mounted cameras) and third-party datasets (e.g., via licensed or web-sourced imagery). The data is uploaded to a central database via a field agent application.

A data processing and normalization subsystem performs data cleaning, annotation, and augmentation, ensuring uniform labeling and enhancing data robustness. The data is normalized for use in machine learning model training through resizing, pixel scaling, and bounding box alignment. Augmentation operations include flips, rotations, scaling, color perturbations, Gaussian noise, artificial weather condition simulation, and lens distortion correction.

A machine learning training subsystem implements a deep learning architecture incorporating convolutional, embedding, and transformer-based components to detect and classify roof objects. The system benchmarks model performance using accuracy, F1 scoring, and confusion matrix metrics, tracking edge cases for retraining.

A deployment subsystem enables real-time inference of roof component identification in production. Image data captured in the field or received from third-party services is transmitted through a verification pipeline to ensure conformity with training standards. The model may be hosted on local or cloud infrastructure with redundancy and load balancing capabilities.

A data verification module identifies and corrects flawed incoming data, including images with multiple properties, improper viewing angles, occluded objects, or excessive noise. The system employs both statistical and machine-learning-based quality checks and may attempt data repair through generative reconstruction or denoising techniques.

A monitoring and dashboard subsystem provides administrators with live performance metrics, including latency, load, data quality, and accuracy reports. Human agents can flag misclassifications through edge devices, providing feedback for model retraining and system improvement.

A reinforcement and maintenance subsystem periodically incorporates new data collected during live operation into retraining cycles. Data augmentation and validation are repeated during each cycle, and new model generations are validated against benchmark datasets. Versioning, rollback, and hardware recovery protocols are included to ensure operational stability.

Through the combination of automated data collection, intelligent data processing, robust verification, and ongoing reinforcement, the system achieves a high degree of automation and reliability in identifying roof components across variable environments.

### BRIEF DESCRIPTION OF THE DRAWINGS

FIG. 1 is a flowchart illustrating an exemplary embodiment of the Roof Component Identification System, showing the sequential interaction between data collection, preprocessing, model training, deployment, verification, and reinforcement processes.

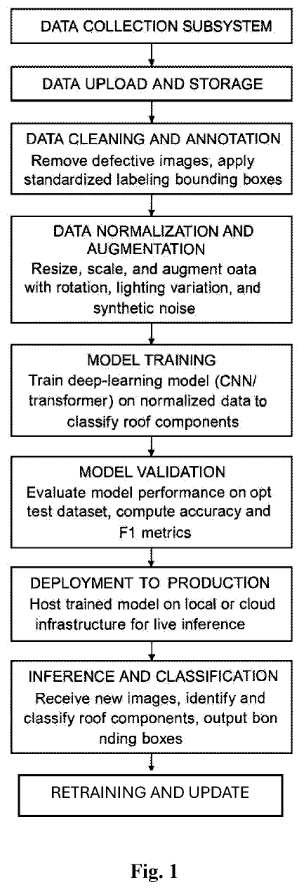

### DETAILED DESCRIPTION OF THE INVENTION

The Roof Component Identification System described herein comprises multiple integrated subsystems that collectively acquire, process, analyze, and continuously improve image-based roof component classification. The system architecture includes both hardware and software components, as well as protocols for data handling and operational feedback. In one embodiment, the Roof Component Identification System may include: a data collection and processing subsystem, a machine learning subsystem, a deployment subsystem, a data verification module, a monitoring subsystem, and a maintenance subsystem.

In one embodiment, the data collection and processing subsystem acquires data from multiple channels. First-party data may be collected by human operators using handheld cameras or drones equipped with high-resolution imaging devices. Images may be captured from multiple viewpoints to ensure complete coverage of the roof's geometry. Drone-mounted cameras may be used to obtain a full 360-degree aerial survey of the property, capturing both overhead and oblique angles. The collected data may be transmitted through an application to a centralized database for processing.

The data collection and processing subsystem may further acquire image data from licensed dataset vendors or third-party online sources. In some implementations, automated web-scraping modules may be configured to extract relevant roof imagery from public databases, using keyword targeting and image filtering. The data collection and processing subsystem may include metadata normalization and secure transfer to the centralized database, which may consist of a storage solution that might be a cloud-hosted database, local server, or a combination thereof to ensure redundancy.

Image data acquired or input to the data collection and processing subsystem may undergo an initial review for fitness or accuracy. Human evaluators may inspect and annotate data samples to mark relevant roofing components, including but not limited to vents, chimneys, skylights, flashing, and gutters. Bounding boxes may be applied according to standardized annotation policies to maintain inter-annotator consistency. Data found unfit may be tagged and stored separately for potential use in automated quality control model training.

In the data collection and processing subsystem, a data verification module may be used to analyze or clean the data or to ensure uniform input for model training. This may include image resizing, color channel separation, pixel scaling, and alignment of bounding boxes to consistent anchor points. Augmentation processes in the data collection and processing subsystem may introduce controlled perturbations—such as geometric transformations, rotations, color adjustments, and simulated environmental conditions—to increase model robustness against diverse input data.

The Roof Component Identification System may further include a machine learning subsystem. The machine learning subsystem may employ a deep learning model architecture comprising convolutional, embedding, and transformer elements. The machine learning subsystem may be trained on the normalized dataset to classify roof components and generate bounding box outputs corresponding to identified objects. In some embodiments, the machine learning subsystem may include dataset loaders to perform randomized batching, class balancing, and multithreaded loading to improve training throughput. The machine learning subsystem may be validated against held-out testing subsets, with performance evaluated using precision, recall, and F1-score metrics.

Once trained, the machine learning subsystem may be deployed to a production environment for live inference via a deployment subsystem. The hosting infrastructure for the Roof Component Identification System may be local or cloud-based (for example, Amazon Web Services, Google VertexAI, or Microsoft Azure). Client applications may interact with the Roof Component Identification System through an application programming interface (API), submitting roof imagery and receiving classification outputs. Redundant hosting instances and load balancing may be utilized to maintain high availability.

Incoming live data may be validated prior to inference by a data verification module. The data verification module processes ensure that images comply with the same quality and formatting standards used during training. The data verification module may detect improper camera angles, occlusions, and noisy or blurred imagery. In one embodiment, statistical methods, such as subzone standard deviation or frequency-domain analysis, may be used to detect blurring or excessive noise. Machine-learning models may also be trained to recognize malformed imagery. When feasible, generative algorithms reconstruct occluded regions, and denoising filters such as BM3D or autoencoder-based processes may be applied.

In some embodiments, the Roof Component Identification System may include a monitoring subsystems. The monitoring subsystem may include a centralized dashboard to track real-time performance metrics, including response latency, compute resource utilization, and classification accuracy. Human agents using the monitoring subsystem may review the system's classifications and flag any errors, which may be logged for retraining. The monitoring subsystem and dashboard may also allow administrators to set alarm thresholds and view flagged images for manual review.

To enhance model performance over time, the Roof Component Identification System may include a reinforcement subsystem. The reinforcement subsystem may execute reinforcement cycles incorporating new data collected during deployment. Data flagged as misclassified or newly acquired may be reprocessed, augmented, and added to the training dataset. The reinforcement subsystem may load the weights of the most recent best-performing model and biases new data inclusion toward previously unseen samples. If a model iteration outperforms its predecessor on benchmark datasets, it may be phased into production using either proportional or blue-green deployment. Versioned model and dataset archives may be maintained with rollback and disaster recovery mechanisms.

In another exemplary embodiment implementing the Roof Component Identification System, the System includes a data collection and training module which is in communication with a storage solution. Data may be acquired via company employees or contracted individuals via cameras, drones, or online databases and information. Such data may then by uploaded to the storage solution manually or through automatic means. The System may further include an application that can be used on a website or a phone to upload the data that is collected.

Data may also be collected from dataset vendors or third party licensing or through scraping of data published on external websites.

In this embodiment, the System may also include a data cleaning process. The data cleaning process may be done by human evaluators viewing data to determine fitness for further use as well as providing annotations for training purposes. Data which is found to be unfit for inclusion will have its reason for exclusion marked, and then be stored in a separate database. Malformed data may be later utilized for creating an automatic data evaluator. After data has been collected and reviewed, it may be processed by an individual or a team of individuals to annotate relevant objects with bounding boxes.

Once data has been acquired, stored, and labeled, it will be subject to a data normalization process. This process will prepare data to be utilized for model training. The data normalization process may include: image sizing normalization to crop and resize to a uniform dimension across samples; pixel color channel split into three color channels such that each channel becomes a distinct vector; pixel value scaling wherein the color channel vectors will be scaled such that data values are within a range between 0 and 1; and bounding box relativity adjustments wherein image data will be adjusted such that content marked within a bounding box for classification is fixed to a common anchor point between samples.

The data may then be subject to a data augmentation process wherein data will be subject to a number of data augmentation perturbations to enhance the robustness of the machine learning model in regards to imperfect data and prevent concept drift. Augmented data may be stored in a separate database from their original source. Data augmentation may include: flips in the horizontal and vertical axes; rotations ranging from 5° to 355°; scaling for the purposes of normalization; color perturbations; addition of Gaussian noise of various magnitudes may be added to data samples; artificial weather modifications; and image morphing to account for differences in source camera lens distortion.

The weather states to be depicted may include: snow, rain, and variable lighting.

Data augmentation may be performed using locally owned hardware, via API call to a cloud hosted augmentation function, or by applying an augmentation function to data hosted natively in a cloud environment.

Data will be served to the augmentation function using a dedicated augmentation pipeline. This pipeline will query the database used to store collected roof item image data, duplicate the data, augment the data, and then store the augmented data in a dedicated database.

The System may also include a dataset loader specification. The dataset loader may be a custom data loader implemented for training and querying the object detection model. This data loader will batch and load data from the database storing training samples, as well as fetch incoming data being received from edge devices at inference time. During the training phase the data loader will execute data shuffling operations to add randomness to the dataset, as well as manage the division of data into subsets used for training, testing, and validations. The data loader will identify if one or more object classification categories are imbalanced and perform under or over sampling accordingly. The data loader may employ parallel loading methods via multithreading to raise system throughput.

The System may also include a detection model. The detection model architecture used for image classification may be a deep learning model utilizing a combination of convolutional, embedding, and linear layers, and may employ transformer architectures as subcomponents. The deep learning model may be implemented using a combination of the OpenCV, Pandas, and Pytorch Python code libraries.

The System may further include a benchmarking subsystem. The benchmarking subsystem may use a combination of accuracy, F1 scoring, and confusion matrices for the purpose of benchmarking the effectiveness of the detection model. In addition, these metrics will be used to identify and track edge cases where model performance is substandard.

The System may also include a production deployment subsystem. The production deployment subsystem will include a model deployment infrastructure, a data storage solution, and a data verification module. The model deployment infrastructure will be made accessible to the client application either via locally hosted hardware or by a cloud hosting solution. In the case of a locally hosted deployment solution the application will be served via a custom API. In the case of a third party cloud hosting solution the application will be served via the platform's API gateway. The client application will serve image data via API call and receive information extracted from the model in response. The model deployment infrastructure may be hosted across multiple redundant servers for the purpose of failure mitigation as well as request load balancing.

Beyond initial training data collected for the purpose of model creation, the System will also process, organize, and store data collected during model deployment. This data will originate from agents using the edge application to take pictures of objects of relevance on client roofs, as well as from queries to third party services providing overhead imaging of client roofs. The edge application will have dedicated functionality to facilitate image collection and upload. Images collected from a live environment will be stored in the data storage solution separate from pre-existing training data and may be subject to manual review before being included in future training sets. Data collected from edge devices will be encrypted before being transmitted to the dedicated database.

As data is transmitted from edge applications to cloud or local resources for processing, the data verification module will implement data verification checks. The purpose of the data verification module is to ensure the data does not contain any flaws that render it infeasible to work with. The first check done by the data verification system will be to determine if the incoming data meets the requirements set forth for data included in the training set. The list of data deformities checked for during this process will include:

Multiple properties in image—Images captured from an overhead perspective may include multiple properties within the same image. In the case such an image is received for live inference, the data verification module will remove all non-relevant buildings from the data.

Improper viewing angles—If object images are not taken at the proper viewing angle as set forth in data collection policies, the model deployment architecturewill not be trained to identify these alternative data patterns. Accordingly the model will identify no object in the received image and throw a “No object detected” warning.

Occlusion of objects—The data verification module will seek to identify if objects are occluded in received imaging. This may be accomplished through sub-segmentation of training bounding boxes for the purpose of partial detection, or may be circumvented using a dedicated occlusion aware training process.

Data staleness—In the case data is received from a third party database, metadata will be queried to determine if the data was generated within an allowable time frame. In the case data is unacceptably stale, a warning will be generated.

Overly noisy or blurred images—The data verification module will attempt to identify if data is too noisy or blurry for analysis. This may be achieved utilizing statistical analysis and dedicated machine learning processes. In the case of statistical analysis subzone standard deviation scores will be calculated and compared against a set average threshold. Additionally, the frequency domain of images will be analyzed to determine the presence of abnormally strong high frequency signal components. In the case of machine learning identification, dedicated models may be trained to identify the difference between clean and malformed images.

The System may further include a data preprocessing module to correct, repair, or improve any issues that may arise in the data or images. When data is detected as containing flaws that prohibit analysis, the following repair processes will be attempted. Image reconstruction—In the case images are malformed due to occlusion, generative AI may be used in an effort to replace the occluded image portions with that is expected to be behind the occluding object. If the classification confidence of object subzones within the reconstructed space are in line with the confidence of known natural subzones, the image may still be used. Denoising/deblurring—In the case of overly noisy or blurry images, statistical denoising and deblurring methods may be utilized. These include BM3D (block-matching and 3D filtering), autoencoder denoising, total variation deblurring, and shock filtering. Collecting flawed data for future data augmentation training—Regardless of if an malformed image can be modified into a processable state, the original image will be stored in a database dedicated for images with the flaws identified. These images will be used in future model training cycles, both for faster automatic malformity detection as well as for model robustness.

The System may also include a monitoring dashboard in order to maintain overwatch of overall system health. This monitoring dashboard will track system performance statistics, alarm thresholds, logging protocols, and human reported accuracy. The system performance statistics to be collected include:

Latency—The average response time of the object identification model when queried by an edge device.

Load—The uptime of allocated computation resources being allocated to model computation.

Null values—The frequency of events where the model expects to receive data from a query, but receives a null data entry.

Input data size—The average size of data being received by the model during a given time window.

Compute time—The average amount of compute time the model is requiring to perform its analysis.

Frequency of system queries by human agents—How often human agents are querying the system.

The monitoring dashboard will allow for the setting of alarms in relation to gathered statistics. When system performance values exit acceptable thresholds a push notification will be sent to system administrators.

The System may also include edge applications used by human agents to query the System (both in the case of agents on roofs taking pictures as well as agents in office querying third party databases) will allow for human review of the classification produced by the System. In instances the agent disagrees with the classification produced by the System, the agent will be able to report this misclassification through a dedicated feature in the edge application. These instances will be logged to the monitoring dashboard, as well as be used for continuous model training. All misclassifications and statistical alarm events will be logged by type in a dedicated database for human review.

The monitoring dashboard may also include a live view portal for querying data that is actively being flagged. The live view portal will allow the operator to manually view images in instances where a human agent has marked a misclassification.

The System may also include an output module. One or more output modules may be designed, trained, and utilized to expedite the generation of relevant information regarding client roofs. These implementations and use cases may include:

Fully automated completion of insurance form—The model may fully generate all information needed to complete a descriptive overview, then automatically populate the insurance form regarding the analyzed roof on a third party platform.

Highlighting areas of visual relevance to human agents—The model may augment images to highlight information relevant to a human reviewer. These augmentations may be the addition of a bounding box around a target portion of an image, or visible brightening of select photo areas.

Selecting photos from a set based on relevance to human agent—A model may review a grouping of images sent in bulk, and automatically identify which of the examined images are most relevant to a human reviewer based on visual contents.

While the invention has been described with respect to illustrative embodiments thereof, the foregoing and various other additions and omissions may be made therein and thereto without departing from the spirit of the invention. Additional variations and enhancements—such as alternate neural network configurations, different image preprocessing methods, or varied cloud-deployment architectures—may also be employed without departing from the scope of the invention as defined by the claims.

What is claimed is:

1. A roof component identification system, comprising:
(a) a data collection and processing subsystem configured to acquire image data of a roof from one or more image sources including at least one of a human-operated camera, a drone-mounted camera, or a third-party imagery provider, the data collection and processing subsystem further configured to receive the image data, perform data cleaning, labeling, and normalization operations, and store the processed data in a database;
(b) a machine learning subsystem trained to identify and classify roofing components within the image data, the machine learning subsystem comprising one or more convolutional or transformer-based neural networks;
(d) a deployment subsystem configured to execute the machine learning subsystem to detect roofing components in received image data and generate classification outputs; and
(e) a reinforcement subsystem configured to receive feedback associated with classification outputs and incorporate said feedback into subsequent retraining of the machine learning subsystem, wherein the reinforcement system continuously improves identification accuracy through iterative retraining cycles based on field feedback and newly collected data.

2. The roof component identification system of claim 1, wherein the data collection and processing subsystem includes a drone configured to perform a 360-degree aerial survey of the roof to capture overhead and oblique images.

3. The roof component identification system of claim 1, wherein the data collection and processing subsystem performs data augmentation consisting of at least one of image rotation, color adjustment, scaling, simulated lighting variation, or addition of synthetic noise.

4. The roof component identification system of claim 1, wherein the machine learning subsystem outputs both a class label and a bounding box corresponding to a detected roofing component.

5. The roof component identification system of claim 1, wherein the reinforcement subsystem is configured to flag misclassified components and store flagged images for retraining.

6. The roof component identification system of claim 1, wherein the data collection and processing subsystem executes quality control operations to identify and correct defective image data including occluded, blurred, or improperly angled images.

7. The roof component identification system of claim 1, wherein the deployment subsystem comprises a cloud-hosted environment with load balancing and redundancy between multiple hosting instances.

8. The roof component identification system of claim 1, further comprising a dashboard interface configured to display real-time performance metrics including accuracy, latency, and data quality statistics.

9. The roof component identification system of claim 1, wherein retraining of the machine learning subsystem includes weighting new data based on frequency of misclassification or novelty of roof type.

10. The roof component identification system of claim 1, wherein the roof component identification system is operable to identify one or more roofing components selected from the group consisting of vents, chimneys, skylights, flashing, gutters, and shingles.

11. The roof component identification system of claim 1, wherein the reinforcement subsystem comprises collecting field feedback, augmenting corresponding image data, retraining the model with updated data, and validating model performance prior to deployment.

12. A method for automated roof component identification and analysis, comprising:
(a) acquiring roof image data from at least one imaging source;
(b) preprocessing the image data by cleaning, labeling, and normalizing the image data for input into a machine learning model;
(c) applying a trained machine learning model to detect and classify roofing components within the image data;
(d) verifying the accuracy of classification results based on user feedback and system analytics; and
(e) retraining the machine learning model using feedback and newly acquired image data to improve subsequent performance.

13. The method of claim 12, wherein the preprocessing step includes augmenting the image data through rotation, scaling, or simulated weather condition modification.

14. The method of claim 12, wherein the verifying step comprises identifying misclassified images and submitting them for model retraining.

15. The method of claim 12, wherein the retraining step includes validating the retrained model against benchmark datasets and deploying the model to a production environment upon exceeding a predetermined performance threshold.
